(19) United States
(12) Patent Application Publication
(10) Pub. No.: US 2023/0404111 A1
(43) Pub. Date: Dec. 21, 2023

(54) NON-ALCOHOLIC BEER-TASTE BEVERAGE

(71) Applicant: SUNTORY HOLDINGS LIMITED, Osaka-shi, Osaka (JP)

(72) Inventors: Anna Ishizuka, Tokyo (JP); Yuichi Kato, Tokyo (JP)

(73) Assignee: SUNTORY HOLDINGS LIMITED, Osaka-shi, Osaka (JP)

(21) Appl. No.: 18/037,501

(22) PCT Filed: Nov. 29, 2021
(86) PCT No.: PCT/JP2021/043534

§ 371 Date: May 17, 2023

(30) Foreign Application Priority Data
Dec. 1, 2020 (JP) 2020-199319

(51) Int. Cl. A23L 2/38; A23L 2/54

(52) U.S. Cl. CPC A23L 2/38; A23L 2/54

(57) ABSTRACT

A non-alcoholic beer-taste beverage comprising 2,3-diethyl-5-methylpyrazine, in which the content of 2,3-diethyl-5-methylpyrazine (Y) is 80 ppb by mass or less, based on the total amount of the non-alcoholic beer-taste beverage.

### TECHNICAL FIELD

The present invention relates to a non-alcoholic beer-taste beverage.

### BACKGROUND ART

Non-alcoholic beer-taste beverages that are carbonated beverages having a beer flavor and having an alcohol percentage of less than 1 (v/v)% have been distributed to the market as beer-taste beverages produced using water and malts as some raw materials. Regarding such non-alcoholic beer-taste beverages, various developments have been made.

For example, Patent Literature 1 discloses a technique regarding a method for producing a non-alcoholic fermented beverage, in which α-glucosidose is added before a fermentation step in the production of a beer, so that the concentration of alcohol generated can be reduced by about 40% to 55%, compared with conventional methods.

### CITATION LIST

### Patent Literature

Patent Literature 1: Patent Publication (Kokai) No. 5-68528 A (1993)

### SUMMARY OF INVENTION

### Technical Problem

In a common non-alcoholic beer-taste beverage produced by the method as described in Patent Literature 1, a sharp aftertaste suitable for beer-taste beverages becomes insufficient in many cases, when compared with ordinary beers. Thus, it has been desired to develop a non-alcoholic beer-taste beverage that provides an improved sharp aftertaste. In addition, it has also been desired to develop a non-alcoholic beer-taste beverage having not only an improved sharp aftertaste, but also the satisfying quality of a beverage suitable for beer-taste beverages, and not having astringency as an unsuitable aftertaste.

### Solution to Problem

The present invention provides a non-alcoholic beer-taste beverage containing 2,3-diethyl-5-methylpyrazine, in which the content of 2,3-diethyl-5-methylpyrazine (Y) is 80 ppb by mass or less, based on the total amount of the non-alcoholic beer-taste beverage. Specifically, the present invention includes the inventions with the following embodiments.

[1]

A non-alcoholic beer-taste beverage comprising 2,3-diethyl-5-methylpyrazine, in which the content of 2,3-diethyl-5-methylpyrazine (Y) is 80 ppb by mass or less, based on the total amount of the non-alcoholic beer-taste beverage.

[2]

The non-alcoholic beer-taste beverage according to the above [1], further comprising tartaric acid.

[3]

The non-alcoholic beer-taste beverage according to the above [2], wherein the content of tartaric acid (X) is 350 ppm by mass or less, based on the total amount of the non-alcoholic beer-taste beverage.

[4]

The non-alcoholic beer-taste beverage according to the above [2] or [3], wherein the ratio [(X)/(Y)] between the content of 2,3-diethyl-5-methylpyrazine (Y) (unit: ppb by mass) and the content of tartaric acid (X) (unit: ppm by mass) is 700 or less.

[5]

The non-alcoholic beer-taste beverage according to any one of the above [1] to [4], wherein the alcohol percentage in the non-alcoholic beer-taste beverage is less than 1.0 (v/v)%.

[6]

The non-alcoholic beer-taste beverage according to any one of the above [1] to [5], wherein the carbon dioxide gas pressure in the non-alcoholic beer-taste beverage is 5.0 kg/cm² or less.

[7]

The non-alcoholic beer-taste beverage according to any one of the above [1] to [6], which is a non-fermented beverage.

### Advantageous Effects of Invention

The non-alcoholic beer-taste beverage according to one preferred embodiment of the present invention can be a beverage, in which both a favorable sharp aftertaste and the satisfying quality of a beverage are improved with good balance. In addition, the non-alcoholic beer-taste beverage according to one preferred embodiment of the present invention can also be a beverage that does not have astringency as an unsuitable aftertaste.

### DESCRIPTION OF EMBODIMENTS

### 1. Non-Alcoholic Beer-Taste Beverage

In the present invention, the “non-alcoholic beer-taste beverage” means a carbonated beverage having a beer-like flavor, which does not belong to “alcohols” defined in the Notification of the Interpretation of the Liquor Tax Law and Other Laws and Orders relating to the Administration of Liquor Affairs (date of enforcement: Apr. 1, 2018).

The alcohol percentage in the non-alcoholic beer-taste beverage according to one embodiment of the present invention may be less than 1 (v/v %). The alcohol percentage is preferably less than 0.5 (v/v)%, more preferably less than 0.1 (v/v)%, further preferably less than 0.01 (v/v)%, and still further preferably less than 0.005 (v/v)%.

Besides, in the present description, the alcohol percentage is indicated with the percentage (v/v %) of volume/volume basis. In addition, the content of alcohol in a beverage can be measured by all of known methods, and it can be measured, for example, by gas chromatography.

The non-alcoholic beer-taste beverage according to one embodiment of the present invention may be a fermented beer-taste beverage, which is obtained by removing alcohol generated in a fermentation step performed using a yeast (a top fermentation yeast or a bottom fermentation yeast) in a production process thereof. Specifically, the fermented beer-taste beverage may be a top-fermented beer-taste beverage brewed by performing a fermentation step using a top fermentation yeast, or may also be a bottom-fermented beer-taste beverage brewed by performing a fermentation step using a bottom fermentation yeast. For such fermentation, a yeast that generates alcohol (Saccharomyces) or a wild-type yeast (Brettanomyces, etc.) may be used. Otherwise, a yeast that does not generate alcohol (Saccharomyces, etc.), a wild-type yeast (Brettanomyces, etc.), bacteria performing lactic acid fermentation or gluconic acid fermentation, and the like, may also be used for such fermentation.

Moreover, the non-alcoholic beer-taste beverage may also be a fermented beverage obtained by terminating the fermentation so that the alcohol becomes less than 1 (v/v %). Otherwise, the non-alcoholic beer-taste beverage may also be a fermented beverage obtained by dilution with water and the like so that the alcohol becomes less than 1 (v/v %). Upon termination of the fermentation, the fermentation is preferably terminated, so that off-flavors such as hydrogen sulfide, diacetyl, 2,3-pentanedione, and acetaldehyde become the threshold or less. However, it is not always necessary to set the off-flavors to be the threshold or less. If the off-flavors such as hydrogen sulfide, diacetyl, 2,3-pentanedione, and acetaldehyde are fused with the flavor of the beer-taste beverage to obtain a favorable flavor, the concentration of the off-flavors is not limited.

Furthermore, the non-alcoholic beer-taste beverage according to one embodiment of the present invention may also be a non-fermented beverage produced without performing such a fermentation step.

When the non-alcoholic beer-taste beverage according to one embodiment of the present invention is a non-fermented beverage, a carbonated beverage that is adjusted to have a beer-like flavor by addition of a beer flavor such as esters, higher alcohols or lactones (for example, isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 1,4-cineole, 1,8-cineole, 2,3-diethyl-5-methylpyrazine, γ-decanolactone, γ-undecalactone, ethyl hexanoate, ethyl 2-methylbutyrate, ethyl n-butyrate, myrcene, etc.), or acids (for example, 2-methyl-2-pentenoic acid and 4-methyl-3-pentenoic acid) so as to impart a beer flavor to the beverage, is also included in the non-fermented non-alcoholic beer-taste beverage according to one embodiment of the present invention.

In addition, the non-alcoholic beer-taste beverage according to one embodiment of the present invention may be either a non-alcoholic beer-taste beverage comprising a malt, in which a malt is used as a raw material, or a non-alcoholic beer-taste beverage not comprising a malt, in which a malt is not used as a raw material. A non-alcoholic beer-taste beverage comprising a malt is preferable, and a non-alcoholic beer-taste beverage comprising a barley malt is more preferable.

Since such a common non-alcoholic beer-taste beverage has a low alcohol percentage, a sharp aftertaste easily becomes insufficient. With respect to such a problem, the present inventors have found that a non-alcoholic beer-taste beverage comprising 2,3-diethyl-5-methylpyrazine is able to improve, with good balance, both a favorable sharp aftertaste suitable for beer beverages and a satisfying quality of a beverage, when compared with conventional non-alcoholic beer-taste beverages. The present invention has been completed based on such findings.

It is adequate if the non-alcoholic beer-taste beverage according to one embodiment of the present invention may comprise 2,3-diethyl-5-methylpyrazine. However, from the viewpoint of achieving a beverage, in which both a sharp aftertaste suitable for beer-taste beverages and a satisfying quality of a beverage can be improved with good balance, the content of 2,3-diethyl-5-methylpyrazine (Y) is preferably 0.02 ppb by mass or more, more preferably 0.05 ppb by mass or more, further preferably 0.07 ppb by mass or more, still further preferably 0.1 ppb by mass or more, still further preferably 0.2 ppb by mass or more, still further preferably 0.3 ppb by mass or more, still further preferably 0.4 ppb by mass or more, and particularly preferably 0.5 ppb by mass or more, based on the total amount (100% by mass) of the non-alcoholic beer-taste beverage.

On the other hand, from the viewpoint of suppressing a bitterness as an unsuitable aftertaste of a beer-taste beverage, the content of 2,3-diethyl-5-methylpyrazine (Y) in the non-alcoholic beer-taste beverage according to one embodiment of the present invention is 80 ppb by mass or less, preferably 70 ppb by mass or less, more preferably 60 ppb by mass or less, further preferably 50 ppb by mass or less, still further preferably 45 ppb by mass or less, still further preferably 40 ppb by mass or less, still further preferably 35 ppb by mass or less, and particularly preferably 30 ppb by mass or less, based on the total amount (100% by mass) of the non-alcoholic beer-taste beverage.

It is preferable that the non-alcoholic beer-taste beverage according to one embodiment of the present invention further comprises tartaric acid. By allowing the present non-alcoholic beer-taste beverage to comprise tartaric acid together with 2,3-diethyl-5-methylpyrazine, a non-alcoholic beer-taste beverage having a further improved sharp aftertaste suitable for beer-taste beverages can be provided.

From the viewpoint of achieving a beverage having a further improved sharp aftertaste suitable for beer-taste beverages, the content of tartaric acid (X) in the non-alcoholic beer-taste beverage according to one embodiment of the present invention is preferably 1.0 ppm by mass or more, more preferably 3.0 ppm by mass or more, further preferably 5.0 ppm by mass or more, still further preferably 7.0 ppm by mass or more, and particularly preferably 10 ppm by mass or more, based on the total amount (100% by mass) of the non-alcoholic beer-taste beverage.

In addition, from the viewpoint of achieving a beverage having a further improved sharp aftertaste suitable for beer-taste beverages, the content of tartaric acid (x) is preferably 700 ppm by mass or less, more preferably 600 ppm by mass or less, even more preferably 500 ppm by mass or less, further preferably 450 ppm by mass or less, still further preferably 400 ppm by mass or less, still further preferably 350 ppm by mass or less, and still further preferably 300 ppm by mass or less, based on the total amount (100% by mass) of the non-alcoholic beer-taste beverage.

In the non-alcoholic beer-taste beverage according to one embodiment of the present invention, from the viewpoint of imparting to a beverage, both a sharp aftertaste suitable for beer-taste beverages and a satisfying quality of a beverage suitable for beer-taste beverages, and also suppressing a bitterness as an unsuitable aftertaste of a beer-taste beverage, the ratio [(X)/(Y)] between the content of tartaric acid (X) (unit: ppm by mass) and the content of 2,3-diethyl-5-methylpyrazine (Y) (unit: ppb by mass) is preferably 0.05 or more, more preferably 0.1 or more, further preferably 0.15 or more, still further preferably 0.2 or more, still further preferably 0.25 or more, particularly preferably 0.3 or more, and further particularly preferably 0.33 or more. The ratio [(X)/(Y)] may also be set to be 0.5 or more, 0.7 or more, 1.0 or more, 2.0 or more, 3.0 or more, 4.0 or more, 5.0 or more, 6.0 or more, 7.0 or more, 8.0 or more, 9.0 or more, 10.0 or more, 15.0 or more, or 20.0 or more. On the other hand, the ratio [(X)/(Y)] is preferably 700 or less, more preferably 650 or less, further preferably 600 or less, still further preferably 550 or less, particularly preferably 500 or less, and further particularly preferably 400 or less. Further, the ratio [(X)/(Y)] may also be set to be 350 or less, 300 or less, 250 or less, or 200 or less.

Besides, in the present description, the content of tartaric acid (X) in the beer-taste beverage can be measured, for example, by high performance liquid chromatography.

Moreover, in the present description, the content of 2,3-diethyl-5-methylpyrazine (Y) in the beer-taste beverage can be measured by gas chromatography-mass spectrometry (GC/MS). An example of a specific measurement method may be a method of measuring the contents of the aforementioned components using the following sample, under the following measurement conditions.

### [Sample]

A solution is prepared by adding 30 to 50 mL of dichloromethane to 10 to 20 g of a beverage used as a measurement subject. Thereafter, a dichloromethane layer of the prepared solution is concentrated under reduced pressure, and 1 μL of the concentrate is then poured in the following GC/MS device, followed by performing a measurement.

[Measurement conditions]
GC/MS device: 7890B/5977B (manufactured by Agilent Technologies)
Column: DB-WAX (manufactured by Agilent Technologies), diameter: 0.25 mm×30 m, film thickness: 0.25 vim
Introduction system: Split 5: 1
Amount injected: 1 μL
Temperature of sample injection port: 220° C.
Column temperature: 40° C. (retention for 1 minute)→temperature increase up to 160° C. at a rate of 10° C./minute→temperature increase up to 200° C. at a rate of 15° C./minute
Gas flow rate: Helium (carrier gas) at a rate of 1 mL/minute
Ion source temperature: 230° C.
Ionization method: EI

The pH of the non-alcoholic beer-taste beverage according to one embodiment of the present invention is not particularly limited, and it is preferably less than pH 4.0, more preferably pH 3.9 or less, further preferably pH 3.8 or less, and particularly preferably pH 3.7 or less. On the other hand, from the viewpoint of suppressing generation of microorganisms and achieving a beverage with an improved flavor, the pH of the non-alcoholic beer-taste beverage according to one embodiment of the present invention is preferably pH 2.0 or more, more preferably pH 2.2 or more, further preferably pH 2.3 or more, still further preferably pH 2.5 or more, still further preferably pH 2.7 or more, and particularly preferably pH 3.0 or more.

The pH of the beer-taste beverage can be adjusted by determining, as appropriate, addition of a diluting solution or carbonated water, the types of raw materials (malts, corn grits, a sugar solution, etc.), the amounts of the raw materials, the type of an enzyme, the additive amount of the enzyme, the timing of adding the enzyme, the saccharification time in a preparation tank, the proteolysis time in the preparation tank, the pH in the preparation tank, the pH in a preparation step (a wort-producing step from addition of the malts until addition of the yeast), the type of an acid used upon the pH adjustment (lactic acid, phosphoric acid, malic acid, tartaric acid, citric acid, etc.), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of a wort (including during saccharification), the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), and the like.

When beer brewing equipment such as a preparation tank or a fermentation tank is not used, pH can be adjusted by determining, as appropriate, the time applied in the production step (a preparation time attended with the mixing of raw materials, etc.), the temperature applied in the production step, the pH applied in the production step, the concentration of an original extract in the production step, etc., as well as addition of a diluting solution or carbonated water, addition of minerals (sodium, salts, potassium salts, calcium salts, magnesium salts, etc.), addition of water containing minerals, and selection of the used amount or type of an acidulant and the used amounts or types of raw materials.

The pH of the carbonated beverage according to the present invention can be measured by the method described in “8.7 pH” in “Revised Version Brewery Convention of Japan (BCOJ) Beer Analysis Method (published by the Brewing Society of Japan, edited by Brewers Association of Japan, Brewery Convention of Japan [Analysis Committee], and enlarged and revised in 2013).”

The total extract amount of the non-alcoholic beer-taste beverage according to one embodiment of the present invention is not particularly limited. From the viewpoint of achieving a beverage having a light taste, the total extract amount is preferably 1.5% by weight or less, more preferably 1.1% by weight or less, further preferably 0.80% by weight or less, and still further preferably less than 0.50% by weight.

It is to be noted that the “total extract amount” is used in the present description to mean an extract value (% by mass) that is obtained by measuring a degassed sample according to “Beer analysis method, 7.2 Extract” in “Revised Version Brewery Convention of Japan (BCOJ) Beer Analysis Method (published by the Brewing Society of Japan, and enlarged and revised in 2013),” edited by Brewers Association of Japan, Brewery Convention of Japan (BCOJ)).”

The color of the non-alcoholic beer-taste beverage according to one embodiment of the present invention is not particularly limited. The non-alcoholic beer-taste beverage according to one embodiment of the present invention may have an amber or golden color, such as the colors of an ordinary beer, or may have a black color such as the color of a black beer, or may also be colorless and transparent. Otherwise, a desired color may be imparted to the beer-taste beverage by adding a coloring agent or the like thereto. The color of the beverage can be determined with the unaided eye, but it may also be determined using total light transmittance, chromaticity, etc.

The non-alcoholic beer-taste beverage according to one embodiment of the present invention may be configured to be filled in a container. Examples of the container may include bottles, plastic bottles, cans, and barrels. In particular, from the viewpoint of the ease of carrying, cans, bottles and plastic bottles are preferable.

### 1.1 Raw Materials

As main raw materials of the non-alcoholic beer-taste beverage according to one embodiment of the present invention, malts may be or may not be used together with water. In addition, hops may also be used, and further, a preservative, a sweetener, water-soluble dietary fibers, a bittering agent or a bitterness-imparting agent, an antioxidant, a flavor, an acidulant, salts, and the like may also be used.

When malts are used as raw materials, the malts mean those obtained by germinating the seeds of mugi plants such as barley, wheat, rye, wild oats, oats, allay, or Avena sativa, then drying them, and then removing roots. The production area and variety of the used malts are not particularly limited.

In one embodiment of the present invention, the used malts are preferably barley malts. The barley malts are one type of malts that are most commonly used as raw materials of beer-taste beverages in Japan. Barley has several types such as two-row barley and six-row barley. All types of barley may be used. Further, in addition to common malts, colored malts and the like can also be used. When such colored malts are used, different types of colored malts may be appropriately used in combination, or only one type of colored malts may also be used.

Moreover, together with such malts, grains other than the malts may also be used.

Examples of such grains may include mugi that does not correspond to malts (e.g. barley, wheat, rye, wild oats, oats, adlay, Avena sativa, etc.), rice (e.g. white rice, brown rice, etc.), corns, kaoliangs, potatoes, beans (e.g. soybeans, garden peas, etc.), buckwheat, sorghum, foxtail millet, barnyard millet, starches obtained from these grains, and extracts thereof. Among these, corns (e.g. corn grits, etc.) are preferably used. In addition, examples of the proteins may include soybean proteins, pea proteins, yeast extracts, and decomposition products thereof.

Besides, when malts are not used, the present non-alcoholic beer-taste beverage may be a non-alcoholic beer-taste beverage, comprising liquid sugar containing a carbon source, and a nitrogen source serving as an amino acid-containing material (e.g. soybean proteins, etc.) of the aforementioned grains other than malts.

Examples of the forms of hops used in one embodiment of the present invention may include pelletized hops, powdered hops, and hop extracts. In addition, the used hops may also be hop-processed products such as isomerized hops and reduced hops.

The additive amount of such hops is adjusted, as appropriate. The additive amount of the hops is preferably 0.0001% to 1% by mass, with respect to the total amount of the beverage.

Moreover, a non-alcoholic beer-taste beverage comprising hops as raw materials becomes a beverage containing an iso-alpha acid that is a component derived from the hops. The content of the iso-alpha acid in the non-alcoholic beer-taste beverage comprising hops may be more than 0.1 ppm by mass, and may also be more than 1.0 ppm by mass, based on the total amount (100% by mass) of the beer-taste beverage.

On the other hand, the content of the iso-alpha acid in a non-alcoholic beer-taste beverage that does not comprise hops may be 0.1 ppm by mass or less, based on the total amount (100% by mass) of the beer-taste beverage.

Besides, in the present description, the content of the iso-alpha acid means a value measured according to a high performance liquid chromatography (HPLC) analysis method described in “Revised Version Brewery Convention of Japan (BCOJ) Beer Analysis Method (published by the Brewing Society of Japan, edited by Brewers Association of Japan, Brewery Convention of Japan [Analysis Committee], and enlarged and revised in 2013).”

The non-alcoholic beer-taste beverage according to one embodiment of the present invention may be a beverage further comprising a preservative.

Examples of the preservative used in one embodiment of the present invention may include: benzoic acid; benzoates such as sodium benzoate; benzoic acid esters such as propyl parahydroxy-benzoate and butyl parahydroxy-benzoate; and dimethyl dicarbonate. Moreover, as such preservatives, commercially available preparations, such as Strong SANPRESER (manufactured by San-Ei Gen F.F.I., Inc.; a mixture of sodium benzoate and butyl benzoate), may also be used.

These preservatives may be used alone or may also be used in combination of two or more types.

When the non-alcoholic beer-taste beverage according to one embodiment of the present invention comprises a preservative, the mixed amount of such a preservative is preferably 5 to 1200 ppm by mass, more preferably 10 to 1100 ppm by mass, further preferably 15 to 1000 ppm by mass, and still further preferably 20 to 900 ppm by mass.

The non-alcoholic beer-taste beverage according to one embodiment of the present invention may also be a beverage further comprising a sweetener.

Examples of the sweetener may include commercially available saccharified solution obtained by decomposing grain-derived starch with an acid, an enzyme or the like, commercially available sugars such as starch syrup, sugar that is trisaccharide or more, sugar alcohol, natural sweeteners such as stevia, and artificial sweeteners.

These sweeteners may be used alone, or may also be used in combination of two or more types.

The form of these sugars may be either a liquid such as a solution, or a solid such as powders.

Moreover, the types of raw material grains for starch, the method of purifying starch, and treatment conditions, such as hydrolysis with an enzyme or an acid, are not particularly limited. For example, conditions for hydrolysis with an enzyme or an acid are determined, as appropriate, so that sugars in which the ratio of maltose is increased may be used. Furthermore, sucrose, fructose, glucose, maltose, trehalose, maltotriose, maltotetraose, isomaltose, isomalttriose, isomalttetraose, a solution thereof (i.e. a sugar solution), and the like can also be used.

Further, examples of the artificial sweetener may include aspartame, acesulfame potassium (acesulfame K), sucralose, and neotame.

The non-alcoholic beer-taste beverage according to one embodiment of the present invention may also be a beverage further comprising water-soluble dietary fibers.

Examples of the water-soluble dietary fibers may include indigestible dextrin, polydextrose, partially hydrolyzed guar gum, pectin, glucomannan, alginic acid, laminarin, fucoidin, and carrageenan. From the viewpoint of versatility such as stability and safety, indigestible dextrin or polydextrose is preferable.

These water-soluble dietary fibers may be used alone, or may also be used in combination of two or more types.

In the carbonated beverage according to one embodiment of the present invention, bitterness is preferably imparted with hops or a hop extract formed by isomerization of alpha acid. Together with such hops or such a hop extract formed by isomerization of alpha acid, the following bittering agents or bitterness-imparting agents may be used. Otherwise, the following bittering agents or bitterness-imparting agents may be used without using such hops and such a hop extract formed by isomerization of alpha acid.

Examples of the bittering agent or the bitterness-imparting agent may include Ganoderma lucidum, Litchi chinensis, Carum carvim, juniper fruit, sage, rosemary, reishi mushroom, laurel, quasin, citrus extract, Picrasma quassioides extract, coffee extract, tea extract, bitter melon extract, lotus germ extract, Aloe arborescens extract, Ganoderma lucidum extract, Litchi chinensis extract, laurel extract, sage extract, caraway extract, naringin, Artemisia absinthium, Artemisia absinthium extract, absinthin, amur cork tree, and pericarp extracts of citrus fruits.

These bittering agents or bitterness-imparting agents may be used alone, or may also be used in combination of two or more types.

The non-alcoholic beer-taste beverage according to one embodiment of the present invention may also be a beverage further comprising an antioxidant.

The antioxidant is not particularly limited, and the substances used as antioxidants in an ordinary beer or a low-malt beer can be used. Examples thereof may include ascorbic acid, erythorbic acid, and catechin.

These antioxidants may be used alone, or may also be used in combination of two or more types.

The non-alcoholic beer-taste beverage according to one embodiment of the present invention may also be a beverage further comprising a flavor.

The flavor is not particularly limited, and a common beer flavor can be used. Such a beer flavor is used to add a beer-like flavor to beverages.

Examples of the beer flavor may include esters and higher alcohols. Specific examples of the beer flavor may include isoamyl acetate, ethyl acetate, n-propanol, isobutanol, acetaldehyde, ethyl caproate, linalool, 4-vinylguaiacol, isoamyl propionate, 2-methyl-2-pentenoic acid, and 4-methyl-3-pentenoic acid.

These flavors may be used alone, or may also be used in combination of two or more types.

The non-alcoholic beer-taste beverage according to one embodiment of the present invention preferably comprises tartaric acid, but it may also be a beverage further comprising an acidulant other than the tartaric acid.

Such an acidulant other than the tartaric acid is not particularly limited, as long as it is a substance having a sourness. Examples of such an acidulant may include phosphoric acid, citric acid, gluconic acid, lactic acid, malic acid, phytic acid, acetic acid, succinic acid, glucono delta lactone, and salts thereof.

Among these acidulants, at least one type selected from among phosphoric acid, citric acid, gluconic acid, lactic acid, malic acid, phytic acid, acetic acid, succinic acid, and salts thereof, is preferable; at least one type selected from among phosphoric acid, citric acid, lactic acid, acetic acid, and salts thereof, is more preferable; and at least one type selected from phosphoric acid and lactic acid is further preferable.

The acidulant used in one embodiment of the present invention is preferably a combination of phosphoric acid and lactic acid.

These acidulants may be used alone, or may also be used in combination of two or more types.

The non-alcoholic beer-taste beverage according to one embodiment of the present invention may also be a beverage further comprising salts.

Examples of such salts may include sodium chloride, potassium acid phosphate, calcium acid phosphate, ammonium phosphate, magnesium sulfate, calcium sulfate, potassium metabisulfite, calcium chloride, magnesium chloride, potassium nitrate, ammonium sulfate, monosodium citrate, disodium citrate, trisodium citrate, and potassium chloride.

These salts may be used alone, or may also be used in combination of two or more types.

The non-alcoholic beer-taste beverage according to one embodiment of the present invention may be a beverage that comprises an extract of one or more types of woods selected from beech, cedar, a cherry tree, oak, Japanese cypress, an apple tree, and a walnut tree. Otherwise, the non-alcoholic beer-taste beverage according to one embodiment of the present invention may be a beverage that does not substantially comprise the aforementioned extract, or may also be a beverage that does not comprise the aforementioned extract.

The non-alcoholic beer-taste beverage according to one embodiment of the present invention may be a beverage comprising an extract of a plant belonging to the genus Quercus, the family Fagaceae. Otherwise, the non-alcoholic beer-taste beverage according to one embodiment of the present invention may be a beverage that does not substantially comprise the aforementioned extract, or may also be a beverage that does not comprise the aforementioned extract.

The non-alcoholic beer-taste beverage according to one embodiment of the present invention may be a beverage in which the content of Spilanthol is 0.1 ppb by mass or more, or may also be a beverage in which the content of Spilanthol is less than 0.1 ppb by mass.

### 1.2 Carbon Dioxide Gas

Carbon dioxide gas comprised in the non-alcoholic beer-taste beverage according to one embodiment of the present invention may be added by mixing the present non-alcoholic beer-taste beverage with carbonated water, or such carbon dioxide gas may be directly added to a raw material solution.

The concentration of carbon dioxide gas in the beer-taste beverage according to one embodiment of the present invention is preferably 0.30 (w/w)% or more, more preferably 0.35 (w/w)% or more, even more preferably 0.40 (w/w)% or more, further preferably 0.42 (w/w)% or more, still further preferably 0.45 (w/w)% or more, still further preferably 0.46 (w/w)% or more, still further preferably 0.47 (w/w)% or more, and particularly preferably 0.48 (w/w)% or more. On the other hand, the concentration of carbon dioxide gas in the beer-taste beverage according to one embodiment of the present invention is preferably 0.80 (w/w)% or less, more preferably 0.70 (w/w)% or less, even more preferably 0.65 (w/w)% or less, further preferably 0.60 (w/w)% or less, still further preferably 0.59 (w/w)% or less, still further preferably 0.58 (w/w)% or less, still further preferably 0.57 (w/w)% or less, still further preferably 0.56 (w/w)% or less, and particularly preferably 0.55 (w/w)% or less.

Besides, in the present description, the concentration of carbon dioxide gas can be measured by immersing a container, in which a beverage used as a target is placed, in a water tank at 20° C. for 30 minutes or more, while sometimes shaking the container, so that the temperature of the beverage is adjusted to be 20° C., and then measuring the concentration using a gas volume measuring device (for example, GVA-500 (manufactured by KYOTO ELECTRONICS MANUFACTURING CO., LTD.), etc.).

When the beer-taste beverage according to one embodiment of the present invention is a container-packed beverage, the carbon dioxide gas pressure of the container-packed beverage may be adjusted, as appropriate, in a range in which the concentration of the carbon dioxide gas becomes in the above-described concentration range. The carbon dioxide gas pressure of the container-packed beverage may be 5.0 kg/cm² or less, 4.5 kg/cm² or less, or 4.0 kg/cm² or less. On the other hand, it may also be kg/cm² or more, 0.50 kg/cm² or more, or 1.0 kg/cm² or more. Besides, these upper limits and lower limits may be combined with one another in any ways, and for example, the carbon dioxide gas pressure of the beverage may be 0.20 kg/cm² or more and 5.0 kg/cm² or less, 0.50 kg/cm² or more and 4.5 kg/cm² or less, or 1.0 kg/cm² or more and 4.0 kg/cm² or less. Moreover, the amount of the carbon dioxide gas contained in the container-packed carbonated beverage according to one embodiment of the present invention may bet set to be 5.0 kg/cm² or less, 4.5 kg/cm² or less, or 4.0 kg/cm² or less. On the other hand, the amount of the carbon dioxide gas contained in the container-packed carbonated beverage according to one embodiment of the present invention may also bet set to be 0.20 kg/cm² or more, 0.50 kg/cm² or more, or 1.0 kg/cm² or more. Besides, these upper limits and lower limits may be combined with one another in any ways, and for example, the carbon dioxide gas pressure of the beverage may be kg/cm² or more and 5.0 kg/cm² or less, 0.50 kg/cm² or more and 4.5 kg/cm² or less, or 1.0 kg/cm² or more and 4.0 kg/cm² or less.

In the present description, the gas pressure means a gas pressure in a container, unless otherwise specified.

The pressure can be measured by a method well known to those skilled in the art, and for example, the pressure can be measured by applying a method comprising fixing a sample set at 20° C. in a gas pressure gauge, then once opening the stopper cock of the gas pressure gauge to discharge gas, then closing the stopper cock again, then shaking the gas pressure gauge, and then reading the value when the indicator reaches a predetermined position, or by using a commercially available gas pressure measurement device.

### 1.3 Other Additives

The non-alcoholic beer-taste beverage according to one embodiment of the present invention may comprise various additives, as necessary, in a range in which the additives do not impair the effects of the present invention.

Examples of such additives may include coloring agents, foaming agents, fermentation promoters, yeast extracts, protein substances such as peptide-containing matters, and condiments such as amino acids.

The coloring agent is used to impart a beer-like color to the beverage, and a caramel coloring or the like can be used. The foaming agent is used to form beer-like foams or to retain the foams of the beverage. Examples of the foaming agent that can be appropriately used herein may include: plant-extracted saponin substances such as soybean saponin and quillaja saponin; vegetable proteins of corns, soybeans, and the like; peptide-containing matters such as collagen peptides; and yeast extracts.

The fermentation promoter is used to promote fermentation with yeasts. For example, yeast extracts, bran ingredients of rice, mugi, and the like, vitamins, and mineral agents can be used alone or in combination.

### 2. Method for Producing Non-Alcoholic Beer-Taste Beverage

The method for producing a non-alcoholic beer-taste beverage of the present invention is not particularly limited, and it is, for example, a method comprising the following Steps (1) to (3).
Step (1): a step of performing at least one treatment of a saccharification treatment, a boiling treatment and a solid-removing treatment, using various types of raw materials, so as to obtain a pre-beverage solution.
Step (2): a step of adding carbon dioxide gas to the pre-beverage solution.
Step (3): a step of adjusting the content of 2,3-diethyl-5-methylpyrazine (Y).

In addition, in the production method according to one embodiment of the present invention, the method may further comprise the following Step (4).
Step (4): a step of adjusting the content of tartaric acid (X).

The above-described individual steps will be described below.

### <Step (1)>

Step (1) is a step of performing at least one treatment of a saccharification treatment, a boiling treatment and a solid-removing treatment, using various types of raw materials, so as to obtain a pre-beverage solution.

For example, when malts are used as various types of raw materials, various types of raw materials including water and malts are added into a preparation pot or a preparation tank, and enzymes such as amylase are added, as necessary. Various types of raw materials other than the malts that may be added herein may include hops, dietary fibers, sweeteners, antioxidants, bitterness-imparting agents, flavors, acidulants, and pigments.

A mixture of various types of raw materials is heated, and starchy materials in the raw materials are saccharified, so as to carry out a saccharification treatment. The temperature and the time applied in the saccharification treatment are adjusted, as appropriate, depending on the types of malts used, the percentage of malts, raw materials other than water and malts, etc. Filtration is carried out after completion of the saccharification treatment, so as to obtain a saccharified solution.

Besides, this saccharified solution is preferably subjected to a boiling treatment.

When hops, bittering agents, etc. are used as raw materials, these substances are preferably added in this boiling treatment. The hops, bittering agents, etc. may be added at a timing between initiation of the boiling of the saccharified solution and before termination of the boiling.

After completion of the boiling treatment, the resultant is transferred into a whirlpool and is cooled to 0° C. to 10° C. so as to prepare a cooling solution. Thereafter, in order to remove solids such as coagulated proteins, a solid-removing treatment is preferably carried out. Thus, a pre-beverage solution is obtained.

Otherwise, instead of the above-described saccharified solution, hops, bittering agents, etc. may be added into a malt extract to which hot water has been added, and a boiling treatment may be then carried out, so as to prepare a pre-beverage solution.

On the other hand, when malts are not used as various types of raw materials, liquid sugar containing a carbon source, a nitrogen source serving as an amino acid-containing raw material other than mugi or malts, hops, dietary fibers, sweeteners, antioxidants, bitterness-imparting agents, flavors, acidulants, pigments, etc. may be mixed with hot water to prepare a liquid sugar solution, and a boiling treatment may be then carried out on the liquid sugar solution, thereby preparing a pre-beverage solution.

In the case of using hops, such hops may be added before performing the boiling treatment, or may also be added at the timing between initiation of the boiling of the liquid sugar solution and before termination of the boiling.

Besides, after completion of the Step (1), a fermentation step using a yeast (a top fermentation yeast or a bottom fermentation yeast) is carried out, and thereafter, a step of performing a treatment of removing alcohol generated in the fermentation step, so as to obtain a fermented beverage having an alcohol percentage of less than 1 (v/v)% (preferably less than 0.5 (v/v)%, more preferably less than 0.1 (v/v)%, further preferably less than 0.01 (v/v)%, and still further preferably less than 0.005 (v/v)%), is carried out, so that a non-alcoholic beer-taste beverage may be produced.

On the other hand, the production method according to one embodiment of the present invention may also be a method, in which the above-described fermentation step and step of removing alcohol are not carried out

### <Step (2)>

Step (2) is a step of adding carbon dioxide gas to the above-described pre-beverage solution.

As a method of adding carbon dioxide gas, a known method applied upon the production of a carbonated beverage can be used. For example, carbon dioxide gas may be added by the admixture of the pre-beverage solution obtained in Step (1) with carbonated water, or such carbon dioxide gas may be directly added to the pre-beverage solution. Using such a known method, it is preferable to adjust the carbon dioxide gas pressure to be in the aforementioned range.

### <Step (3) and Step (4)>

Step (3) is a step of adjusting the content of 2,3-diethyl-5-methylpyrazine (Y), and Step 4 is a step of adjusting the content of tartaric acid (X).

Step (3) and Step (4) may be carried out at any timing of, before or after the saccharification treatment, before or after the boiling treatment, and before or after the solid-removing treatment, which are performed in Step (1), or may also be carried out before or after Step (2) performed after completion of the Step (1). However, from the viewpoint of precisely adjusting the contents of these components in the finally produced beverage, Step (3) and Step (4) are preferably carried out after completion of Step (1) and before initiation of Step (2).

Besides, the order of performing Step (3) and Step (4) is not particularly limited, and either step may be performed first.

In Step (3), 2,3-diethyl-5-methylpyrazine or an additive containing 2,3-diethyl-5-methylpyrazine is added to the beverage before adjustment, or the amount of 2,3-diethyl-5-methylpyrazine obtained in the preparation step or the fermentation step is adjusted, so that the content (Y) may be adjusted. Otherwise, the content of 2,3-diethyl-5-methylpyrazine (Y) in the beverage before adjustment is measured, and based on the measured value, 2,3-diethyl-5-methylpyrazine is added, or water is added to the beverage to dilute it, so that the content (Y) may be adjusted to be in the aforementioned range. Besides, when the content (Y) has already been in a desired range, it is unnecessary to perform the operation of adding 2,3-diethyl-5-methylpyrazine or adding water or carbonated water to the beverage to dilute it according to the present step.

Further, as with Step (3), even in Step (4), tartaric acid is added to the beverage before adjustment, so that the content of tartaric acid (X) may be adjusted. Otherwise, the content of tartaric acid (X) in the beverage before adjustment is measured, and based on the measured value, tartaric acid is added, or water is added to the beverage to dilute it, so that the content (X) may be adjusted to be in the aforementioned range. Besides, when the content (X) has already been in a desired range because of the presence of tartaric acid derived from the raw materials in the beverage before adjustment, it is unnecessary to perform the operation of adding tartaric acid or adding water to the beverage to dilute it according to the present step.

After completion of these steps, the steps performed in the production of non-alcoholic beer-taste beverages that are well known to those skilled in the art, such as a liquor storage step and a filtration step, may be carried out.

The thus obtained non-alcoholic beer-taste beverage according to one embodiment of the present invention is filled in a predetermined container, and is distributed as a product to the market.

The method of filling the beverage in a container is not particularly limited, and a method of filling a beverage in a container that is well known to those skilled in the art can be applied. By performing a step of filling the beverage in a container, the non-alcoholic beer-taste beverage of the present invention is filled and hermetically sealed in the container. In such a step of filling the beverage in a container, containers having any forms and/or being made of any materials may be used, and examples of such a container are as described above.

### EXAMPLES

Hereinafter, the present invention will be described in more detail in the following examples, etc. However, these examples are not intended to limit the scope of the present invention.

### Examples 1 to 12 and Comparative Examples 1 to 3

Water, malts and hops were used as raw materials, and these raw materials were subjected to a saccharification treatment to obtain a wort. A fermentation step using a yeast was not performed on the obtained wort, and 2,3-diethyl-5-methylpyrazine and tartaric acid were added to the wort, so that the contents shown in Tables 1 to 4 could be obtained. Moreover, in all of the examples and the comparative examples, carbon dioxide gas was added to the wort, so as to prepare non-alcoholic beer-taste beverages each having a carbon dioxide gas pressure of 2.3 kg/cm 2, a pH value of less than 4.0, and an alcohol percentage of 0.0 (v/v)%.

Besides, in Examples 1 to 4 and Comparative Example 1, the non-alcoholic beer-taste beverages were prepared without adding tartaric acid; whereas in Comparative Examples 1 and 2, the non-alcoholic beer-taste beverages were prepared without adding 2,3-diethyl-5-methylpyrazine.

Thereafter, 6 panelists who had been trained on a daily basis performed a sensory evaluation on the obtained non-alcoholic beer-taste beverages, with regard to “a sharp aftertaste suitable for beer-taste beverages,” “the satisfying quality of a beverage suitable for beer-taste beverages,” and “the presence or absence of a bitterness as an unsuitable aftertaste of a beer-taste beverage,” based on the following score criteria, with scores in 0.5 steps in the range of 3.0 (maximum value) to 1.0 (minimum value). For the evaluation, samples compatible with the following criteria “3.0,” “2.5,” “2.0,” “1.5” and “1,0” had previously been prepared, and thus, the standards among individual panelists were intended to be unified. Besides, in all of the sensory evaluations shown in Tables 1 to 3, a score value difference of 1.5 or more was not found among individual panelists, with respect to an identical beverage. Tables 1 to 4 show the mean values of the scores given by individual panelists.

### [Score Criteria for Sharp Aftertaste Suitable for Beer-Taste Beverage]

“3.0”: Favorable sharp aftertaste suitable for beer-taste beverages is strongly felt.
“2.5”: Favorable sharp aftertaste suitable for beer-taste beverages is clearly felt.
“2.0”: Favorable sharp aftertaste suitable for beer-taste beverages is felt to a certain extent.
“1.5”: Favorable sharp aftertaste suitable for beer-taste beverages is not felt so much.
“1.0”: Favorable sharp aftertaste suitable for beer-taste beverages is not felt

### [Score Criteria for Satisfying Quality of Beverage Suitable for Beer-Taste Beverage]

“3.0”: Favorable satisfying quality of a beverage suitable for beer-taste beverages, is strongly felt.
“2.5”: Favorable satisfying quality of a beverage suitable for beer-taste beverages, is clearly felt.
“2.0”: Favorable satisfying quality of a beverage suitable for beer-taste beverages, is felt to a certain extent.
“1.5”: Favorable satisfying quality of a beverage suitable for beer-taste beverages, is not felt so much.
“1.0”: Favorable satisfying quality of a beverage suitable for beer-taste beverages, is not felt

### [Score Criteria for Presence or Absence of Bitterness as Unsuitable Aftertaste of Beer-Taste Beverage]

“3.0”: Bitterness as an unsuitable aftertaste is not felt at all.
“2.5”: Bitterness as an unsuitable aftertaste is hardly felt.
“2.0”: Bitterness as an unsuitable aftertaste is slightly felt.
“1.5”: Bitterness as an unsuitable aftertaste is clearly felt.
“1.0”: Bitterness as an unsuitable aftertaste is strongly felt.

Moreover, from the mean values of the scores of the above-described 3 sensory evaluation items given by individual panelists, individual beer-taste beverages were subjected to comprehensive evaluation according to the following evaluation criteria. The results are as shown in Tables 1 to 3.

### [Comprehensive Evaluation]

“A”: The mean values of the scores of the 2 sensory evaluation items, namely, the “sharp aftertaste suitable for beer-taste beverages” and “the satisfying quality of a beverage suitable for beer-taste beverages” are both 2.0 or more, and the mean value of the scores of the sensory evaluation item, “the presence or absence of a bitterness as an unsuitable aftertaste of a beer-taste beverage,” given by individual panelists is 2.5 or more.
“B”: At least one of the mean values of the scores of the 2 sensory evaluation items, namely, the “sharp aftertaste suitable for beer-taste beverages” and “the satisfying quality of a beverage suitable for beer-taste beverages” is less than 2.0, and/or the mean value of the scores of the sensory evaluation item, “the presence or absence of a bitterness as an unsuitable aftertaste of a beer-taste beverage,” given by individual panelists is less than 2.5.

TABLE 1

| | | | | | | Comp. |
|---|---|---|---|---|---|---|
| | | Ex. 1 | Ex. 2 | Ex. 3 | Ex. 4 | Ex. 1 |
| Content of tartaric | ppm by | 0 | 0 | 0 | 0 | 0 |
| acid (X) | mass | | | | | |
| Content of 2,3- | ppb by | 0.5 | 1.0 | 10.0 | 30.0 | Not |
| diethyl-5- | mass | | | | | detected |
| methylpyrazine | | | | | | |
| (Y) | | | | | | |
| (X)/(Y) | | 0.00 | 0.00 | 0.00 | 0.00 | 0.00 |
| Sharp | | 2.0 | 2.0 | 2.0 | 2.0 | 1.5 |
| aftertaste suitable | | | | | | |
| for beer-flavored | | | | | | |
| beverages | | | | | | |
| Satisfying quality | | 2.0 | 2.5 | 3.0 | 3.0 | 1.5 |
| of beverage | | | | | | |
| suitable for beer- | | | | | | |
| flavored | | | | | | |
| beverages | | | | | | |
| Astringency | | 3.0 | 3.0 | 3.0 | 2.5 | 3.0 |
| as unsuitable | | | | | | |
| aftertaste of beer- | | | | | | |
| flavored beverage | | | | | | |
| Comprehensive | | A | A | A | A | B |
| evaluation | | | | | | |

TABLE 2

| | | | | | | Comp. |
|---|---|---|---|---|---|---|
| | | Ex. 5 | Ex. 6 | Ex. 7 | Ex. 8 | Ex. 2 |
| Content of | ppm by | 10 | 10 | 10 | 10 | 10 |
| tartaric acid (X) | mass | | | | | |
| Content of | ppb by | 0.5 | 1.0 | 10.0 | 30.0 | Not |
| 2,3-diethyl-5- | mass | | | | | detected |
| methyl- | | | | | | |
| pyrazine (Y) | | | | | | |
| (X)/(Y) | | 20.00 | 10.00 | 1.00 | 0.33 | 0.00 |
| Sharp aftertaste | | 2.5 | 2.5 | 2.5 | 2.5 | 2.0 |
| suitable for beer- | | | | | | |
| flavored | | | | | | |
| beverages | | | | | | |
| Satisfying quality | | 2.0 | 2.5 | 3.0 | 3.0 | 1.5 |
| of beverage | | | | | | |
| suitable for beer- | | | | | | |
| flavored | | | | | | |
| beverages | | | | | | |
| Astringency as | | 3.0 | 3.0 | 3.0 | 2.5 | 3.0 |
| unsuitable | | | | | | |
| aftertaste of beer- | | | | | | |
| flavored beverage | | | | | | |
| Comprehensive | | A | A | A | A | B |
| evaluation | | | | | | |

TABLE 3

| | | Ex. | Ex. | Ex. | Ex. |
|---|---|---|---|---|---|
| | | 9 | 10 | 11 | 12 |
| Content of tartaric acid (X) | ppm by | 50 | 50 | 50 | 50 |
| | mass | | | | |
| Content of 2,3-diethy1-5- | ppb by | 0.5 | 1.0 | 10.0 | 30.0 |
| methylpyrazine (Y) | mass | | | | |
| (X)/(Y) | | 100.00 | 50.00 | 5.00 | 1.67 |
| Sharp aftertaste suitable for | | 3.0 | 3.0 | 3.0 | 3.0 |
| beer-flavored beverages | | | | | |
| Satisfying quality of beverage | | 2.0 | 2.5 | 3.0 | 3.0 |
| suitable for beer-flavored | | | | | |
| beverages | | | | | |
| Astringency as unsuitable | | 3.0 | 3.0 | 3.0 | 2.5 |
| aftertaste of beer-flavored | | | | | |
| beverage | | | | | |
| Comprehensive evaluation | | A | A | A | A |

TABLE 4

| | | | | | | Comp. |
|---|---|---|---|---|---|---|
| | | Ex. 13 | Ex. 14 | Ex. 15 | Ex. 16 | Ex. 3 |
| Content of | ppm by | 200 | 200 | 200 | 200 | 400 |
| tartaric acid (X) | mass | | | | | |
| Content of 2,3- | ppb by | 0.5 | 1.0 | 10.0 | 30.0 | 100.0 |
| diethyl-5- | mass | | | | | |
| methylpyrazine | | | | | | |
| (Y) | | | | | | |
| (X)/(Y) | | 400.00 | 200.00 | 20.00 | 6.67 | 4.000 |
| Sharp | | 2.5 | 2.5 | 2.5 | 2.5 | 2.0 |
| aftertaste suitable | | | | | | |
| for beer- | | | | | | |
| flavored beverages | | | | | | |
| Satisfying quality | | 2.0 | 2.5 | 3.0 | 3.0 | 3.0 |
| of beverage | | | | | | |
| suitable for beer- | | | | | | |
| flavored beverages | | | | | | |
| Astringency | | 2.5 | 2.5 | 2.5 | 2.5 | 1.0 |
| as unsuitable | | | | | | |
| aftertaste of beer- | | | | | | |
| flavored beverage | | | | | | |
| Comprehensive | | A | A | A | A | B |
| evaluation | | | | | | |

As shown in Tables 1 to 4, the non-alcoholic beer-taste beverages of Examples 1 to 16 resulted to have a favorable sharp aftertaste suitable for beer-taste beverages and a favorable satisfying quality of a beverage suitable for beer-taste beverages, and also resulted to have a suppressed bitterness as an unsuitable aftertaste. In contrast, the non-alcoholic beer-taste beverages of Comparative Example 1 and Comparative Example 2 were beverages, from which a favorable satisfying quality of a beverage suitable for beer-taste beverages was not felt. Moreover, the non-alcoholic beer-taste beverage of Comparative Example 3 was a beverage, from which a bitterness as an unsuitable aftertaste of a beer-taste beverage was felt.

1. A non-alcoholic beer-taste beverage comprising 2,3-diethyl-5-methylpyrazine, in which the content of 2,3-diethyl-5-methylpyrazine (Y) is 80 ppb by mass or less, based on the total amount of the non-alcoholic beer-taste beverage.

2. The non-alcoholic beer-taste beverage according to claim 1, further comprising tartaric acid.

3. The non-alcoholic beer-taste beverage according to claim 2, wherein the content of tartaric acid (X) is 350 ppm by mass or less, based on the total amount of the non-alcoholic beer-taste beverage.

4. The non-alcoholic beer-taste beverage according to claim 2, wherein the ratio [(X)/(Y)] between the content of 2,3-diethyl-5-methylpyrazine (Y) (unit: ppb by mass) and the content of tartaric acid (X) (unit: ppm by mass) is 700 or less.

5. The non-alcoholic beer-taste beverage according to claim 1, wherein the alcohol percentage in the non-alcoholic beer-taste beverage is less than 1.0 (v/v)%.

6. The non-alcoholic beer-taste beverage according to claim 1, wherein the carbon dioxide gas pressure in the non-alcoholic beer-taste beverage is 5.0 kg/cm² or less.

7. The non-alcoholic beer-taste beverage according to claim 1, which is a non-fermented beverage.
